(19) United States
(12) Patent Application Publication
(10) Pub. No.: US 2023/0330942 A1
(43) Pub. Date: Oct. 19, 2023

(54) Erodible Support Materials for Additive Manufacturing

(71) Applicant: California Institute of Technology, Pasadena, CA (US)

(72) Inventors: Scott N. Roberts, Altadena, CA (US); Mauricio Zuleta, Pasadena, CA (US)

(73) Assignee: California Institute of Technology, Pasadena, CA (US)

(21) Appl. No.: 18/302,598

(22) Filed: Apr. 18, 2023

Related U.S. Application Data
(60) Provisional application No. 63/332,073, filed on Apr. 18, 2022.

(51) Int. Cl. B29C 64/40; B29C 64/245; B29C 64/393; B33Y 80/00; B33Y 50/02

(52) U.S. Cl. CPC B29C 64/40; B29C 64/245; B29C 64/393; B33Y 80/00; B33Y 50/02

(57) ABSTRACT

A process may obtain a design for an erodible support structure and a part. A process may use an additive manufacturing process to manufacture the part and the erodible support structure, wherein the erodible support structure is configured to mechanically support the part during the additive manufacturing process, and wherein the erodible support structure has elevated porosity compared to the part and is erodible by mechanical and chemical means.

### CROSS-REFERENCE TO RELATED APPLICATIONS

The current application claims priority to U.S. Provisional Patent Application No. 63/332,073 filed Apr. 18, 2022, the disclosure of which is incorporated herein by reference in its entirety for all purposes.

### GOVERNMENT SUPPORT STATEMENT

This invention was made with government support under Grant No. 80NMO0018D0004 awarded by NASA (JPL). The government has certain rights in the invention.

### FIELD OF THE INVENTION

The present invention is generally related to additive manufacturing. More particularly it is directed to support materials for additive manufacturing.

### BACKGROUND

Additive manufacturing (AM), or 3d printing, is a manufacturing method which can enable a significant increase in the degrees of freedom for designing parts. Many additive manufacturing methods rely upon taking a solid model, turning it into a series of 2d slices, and then fabricating, by the printing machine, one slice at a time (be it through laser/electron beam sintering, UV polymerization, locally applying a binder to powder, or other methods). While any shape can be attempted to be printed, not every geometry is able to be formed successfully. Careful consideration is needed of supporting structures, controlling residual stresses, providing heat sink paths, and minimizing warping.

Support structure comes in a variety of forms. Often, it is the same material being printed as the part, only generated in such a way that it is easy to remove. This is common in methods such as laser or e-beam powder bed and stereolithography (SLA) techniques. In the case of binder jetting, a different binder can be deposited at the support location, such that it is strong enough to survive printing, but weak enough it can be fractured out later. SLA can also use a different ultraviolet (UV) curing resin from the part being printed, often one which is soluble in water or caustic solution.

### SUMMARY OF THE INVENTION

In some embodiments, a process can be for improving precision in additive manufacturing processes. In an embodiment, the process including: obtaining a design for an erodible support structure and a part; and using an additive manufacturing process to manufacture the part and the erodible support structure; wherein the erodible support structure is configured to mechanically support the part during the additive manufacturing process, and wherein the erodible support structure has a porosity greater than 10%.

In another embodiment, the process further including removing the erodible support structure from the part.

In a further embodiment, the process further including removing the erodible support structure from the part by mechanical means.

In yet another embodiment, wherein the erodible support structure is configured to have selected thermal properties based on varying the porosity throughout the erodible support structure.

In another embodiment again, wherein the erodible support structure is deposited such that it at least partially envelopes the part.

In still another embodiment, wherein the erodible support and the part are made of a common material.

In a still further embodiment, wherein the porosity of the erodible support is achieved by varying process parameters, and wherein process parameters can consist of at least one from a list of: scan speed, laser power, cross-hatch spacing, layer thickness, rotation amount, beam spot size, beam focal size, and/or fill pattern.

In a yet further embodiment, wherein the erodible support structure has a porosity greater than around 20%.

In yet another embodiment again, wherein the erodible support structure has a porosity greater than around 35%.

In a further embodiment again, the process further including removing the erodible support structure from the part by bead blasting.

In a still further embodiment again, the process further including removing the erodible support structure from the part by chemical means.

In an additional further embodiment, the process further including removing the erodible support structure from the part by corroding away at least a portion of the erodible support structure.

In some embodiments, a process can be for improving precision in additive manufacturing processes. In an embodiment, the process including: obtaining a design for an erodible support structure and a part; and using an additive manufacturing process to manufacture the part and the erodible support structure; wherein the erodible support structure is configured to mechanically support the part during the additive manufacturing process, and wherein the erodible support structure has a first portion with a first porosity and a second portion with a second porosity, the first porosity different from the second porosity.

In another embodiment, the process further including removing the erodible support structure from the part.

In a further embodiment, the process further including removing the erodible support structure from the part by abrasive means.

In another further embodiment, wherein the first portion has a higher percent porosity than the second portion, and the part is around fully dense.

In yet another embodiment, wherein the first portion has a porosity greater than around 20%.

In still another embodiment, wherein the first portion has a porosity greater than around 35%.

In another embodiment again, wherein the first portion is configured to be erodible and the second portion is configured to be not erodible.

In another further embodiment again, wherein the first portion is configured to be erodible by bead blasting the second portion is configured to have a higher effective thermal conductivity than the first portion.

In yet another embodiment again, wherein the first portion and the second portion are made of a common material.

In still another embodiment again, wherein the first portion, the second portion and the part are made of a material selected from a list, the list consisting of aluminum, titanium, copper, steel, Ni-based alloys, Co-based alloys, Cr-based alloys, refractory alloys, intermetallics, and high entropy alloys.

In yet still another embodiment, wherein the porosity of the erodible support is achieved by varying process parameters, and wherein process parameters can consist of at least one from a list of: scan speed, laser power, cross-hatch spacing, layer thickness, rotation amount, beam spot size, beam focal size, and/or fill pattern.

In yet still another embodiment again, wherein the first portion is deposited such that it fully envelopes the part, and the second portion is deposited such that it fully envelopes the first portion.

In a yet further embodiment, wherein the first portion is in contact with the part at a point of contact and the second portion is distal to the point of contact.

In a still further embodiment, wherein the first portion is deposited such that it mechanical support a first portion of the part, and the second portion is deposited such that it envelops a second portion of the part.

In some embodiments, an additive manufacturing output can have a porosity. In an embodiment, the additive manufacturing output including: a part; and an erodible support structure, the erodible support structure configured to mechanically support the part during an additive manufacturing process, and wherein the erodible support structure has a porosity greater than 10%.

In another embodiment, the erodible support structure is capable of being removed by abrasive means.

In yet another embodiment, the erodible support structure is configured to have selected thermal properties based on varying the porosity throughout the erodible support structure.

In still another embodiment, the erodible support structure at least partially fully envelopes the part.

In another embodiment gain, the erodible support and the part are made of a common material.

In another further embodiment, the porosity of the erodible support is achieved by varying process parameters, and wherein process parameters can consist of at least one from a list of: scan speed, laser power, cross-hatch spacing, layer thickness, rotation amount, beam spot size, beam focal size, and/or fill pattern.

In still yet another embodiment, the erodible support structure has a porosity greater than around 20%.

In yet another embodiment again, the erodible support structure has a porosity greater than around 35%.

In some embodiments an additive manufacturing output can have a first portion and a second portion. In an embodiment, the additive manufacturing output including: a part; and an erodible support structure, the erodible support structure configured to mechanically support the part during an additive manufacturing process, and wherein the erodible support structure has a first portion with a first porosity and a second portion with a second porosity, the first porosity different from the second porosity.

In another embodiment, the erodible support structure is capable of being removed from the part by abrasive means.

In yet another embodiment, the first portion has a higher percent porosity than the second portion, and the part is around fully dense.

In still another embodiment, the first portion has a porosity greater than around 20%.

In another embodiment again, the first portion has a porosity greater than around 35%.

In yet still another embodiment, the first portion is configured to be erodible and the second portion is configured to not be erodible.

In another further embodiment, the first portion is configured to be erodible by bead blasting the second portion is configured to have a higher effective thermal conductivity than the first portion.

In still another further embodiment, the first portion and the second portion are made of a common material.

In still another embodiment again, the first portion, the second portion and the part are made of a material selected from a list, the list consisting of aluminum, titanium, copper, steel, Ni-based alloys, Co-based alloys, Cr-based alloys, refractory alloys, intermetallics and high entropy alloys.

In yet another embodiment again, the porosity of the erodible support is achieved by varying process parameters.

In still yet another embodiment again, the first portion is deposited such that it fully envelopes the part, and the second portion is deposited such that it fully envelopes the first portion.

In a yet still further embodiment, the first portion is in contact with the part at a point of contact and the second portion is distal to the point of contact.

### BRIEF DESCRIPTION OF THE DRAWINGS

The description and claims will be more fully understood with reference to the following figures and data graphs, which are presented as exemplary embodiments of the invention and should not be construed as a complete recitation of the scope of the invention.

FIG. 1 conceptually illustrates an example of a common support structure.

FIG. 2A through B conceptually illustrates an example part printed with an enveloping erodible support structure.

FIG. 3A through D conceptually illustrates an example structure printed with erodible support, and also the progressive removal of erodible support.

FIG. 4 conceptually illustrates an example additive manufacturing process incorporating the use of an erodible support.

FIG. 5 conceptually illustrates an example of an erodible support structure showing various porosity portions supporting a part.

FIG. 6 conceptually illustrates an example of an erodible support structure showing various porosity portions surrounding a part.

FIG. 7 conceptually illustrates an example arrangement of erodible support structures with a supported part.

### DETAILED DESCRIPTION

In several embodiments, an erodible support structure can be used as a support structure during a 3d printing process. The erodible support structure can have an elevated porosity compared with fully dense materials. The porosity can be selected and/or varied for throughout the erodible support structure such that the thermal properties of the support can be tuned and such that mechanical means (e.g., bead blasting) and/or chemical means (e.g., etching) can be used to remove the erodible support structure. The improvements described herein can have at least the benefit of reducing labor costs for 3d printing, and/or can allow production of previously unavailable geometries. Several embodiments allow additive manufacturing to be performed with improved precision.

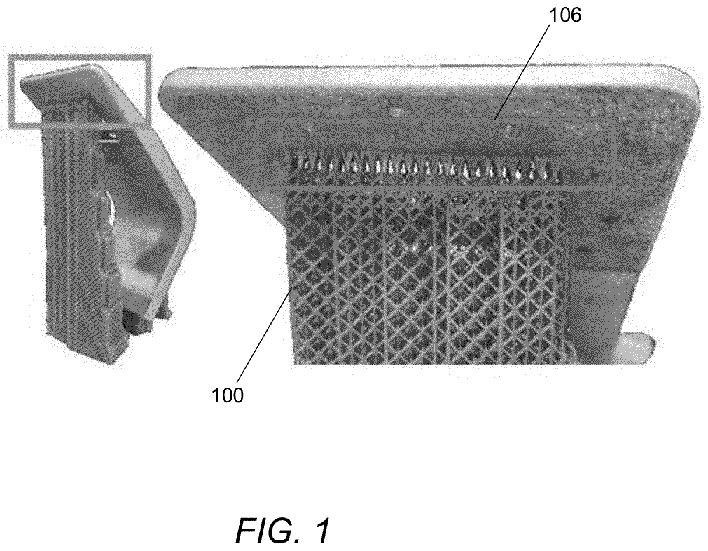

A common support structure technique is to use a lattice-like material. An example of a common support structure from the prior art is depicted in FIG. 1.

The depicted support structure 100 is a structure with a specific geometry (e.g., selected geometry) that can be used to provide support structure benefits. The support structure benefits can include holding the part down to the plate, preventing and/or reducing warping (thermal stresses tend to bend the part in a “potato chip” fashion), allowing overhangs greater than could otherwise be built, and/or providing a path for heat out of the part. Each of these benefits can be is important to create a successful part. If a piece is not held firmly to the plate, it could slightly deform upwards from the build tray. In some examples, the part could then snag the re-coater blade as it spreads powder. This can deform the part, hurt tolerances, and/or cause a failed build.

This is particularly a problem in flexible parts, such as those with high aspect ratios and/or “springy” geometries. The path for heat to flow is also an important consideration, as the flow of energy from the beam, into the part, and then into the powder bed and build plate determine the microstructure and residual stress state of the part. A downside of the support structure 100 and other similar lattice-like support structures is that they can tend to be work intensive to remove.

Traditional support structures are generally printed at nearly the same strength as the printed part. In some instances, a faster scan speed, increased cross-hatch spacing, or greater layer thicknesses is can be used. The support structure still retains substantial strength, however, and behaves much like a fully dense structure. In order to cut through it, one needs to employ band saws, wire cutters, oscillating multitools, EDMs, or other methods. Once the supports have been removed, the stubs from the support material still require hand-filing or sanding to fix. While many traditional support structures are designed to be easily removed from the build plate, it can still require significant post-finishing steps due to all the metal-metal contact in the inverted-triangle region. For smaller parts, support structures can take up a significant portion of the final part's surface. This means the major of the surface will have to be hand finished or post-machined when traditional support structures are used.

Often the support removal stage can take more hands-on time than any other part of the printing process. Additionally, the supports can leave small distortions on the surface of the part, visible as bumps, ridges, or other non-uniformities. To remove them, effort can be required on post-finishing via sanding, bead blasting, slurry honing, polishing, etc. Each of these additional steps drives up cost, and can limit scalability of 3d printing when support removal needs to be done by hand.

Various embodiments of the invention include a method for 3d printing porous support structures (e.g., erodible support structures) which eliminates much of the required hand work and post processing associated with support material for additive processes. Instead of printing a fully dense, or nearly full strength, support structure requiring removal via breaking the support members, several embodiments can print a porous, relatively (e.g., relative to a fully dense or nearly fully dense support structure) weak structure which can permit the support structure to be eroded away (e.g., by bead blasting means and/or chemical means), yet has sufficient strength to support the part. In various embodiments of erodible support structures can be eroded using mechanical (e.g., abrasive) methods for removing material. Example methods for abrasive removal of erodible support structures includes dry ice pellets, slurry abrasives, tumbling, bead blasting and other methods. In accordance with embodiments of the invention, an erodible support structure can have high porosity that can serve to enhance corrosion rates for removing the support structure material. For many embodiments, corrosion can be a preferred method for cleaning printed parts of their associated erodible support structures. In many embodiments using corrosion for eroding an erodible support structure can be beneficial for allowing the erosion to be performed volumetrically (e.g. by immersing some portion of an erodible support in a fluid).

A method of several embodiments is for printing a porous support structure. A porous support structure can provide heat sinking and strength to support the part, yet it can also be relatively fragile making it easy to remove. Traditional removal methods listed elsewhere herein may be used, but an advantage of the novel porous support method is that a number of other techniques requiring less effort and time are now made available, such as bead blasting, rapid etching (e.g., due to enhanced surface area), water jetting, ultrasonicating, tumbling, media milling, and/or dry ice abrasion, etc.

An advantage of several embodiments is that porous support structures can be used without adding any additional material to the print bed, so there is no added concern of contamination. Some additive manufacturing processes (e.g., 3d printing processes, laser powder bed fusion, laser metal powder bed fusion) can be controlled via laser settings. Laser setting can be locally varied as needed for the part. In several embodiments, settings (e.g., laser settings) can be locally varied throughout a part during 3d printing to print at least one (e.g., a variety) of custom erodible supports. In cases where more strength or heat sinking is required, the porosity can be varied throughout the support structure. In several embodiments the porosity and geometry of support structures can be selected such that they are tailored to build a stronger support variant, and/or where parts are very fragile, a delicate support can be chosen, one just strong enough to support the part. In several embodiments a support structure can have a first, higher porosity at a position adjacent to the part, and can have a second lower porosity at a position spaced away from the part, in this way the support could have good erodibility in the vicinity of the part, and simultaneously have heat transfer benefits of lower porosity (e.g., high heat transfer potential) in portions of the support spaced away from the part.

To speed up printing and removal, a hybrid approach can also be used for support structures. In accordance with embodiments of the invention, an easily erodible support structure can be printed at fragile regions needing little support, while stronger supports can be built in areas requiring greater support as needed. Pre-build simulations can be run to determine at which points each support setting should be used. Additionally, many embodiments allow a composite of erodible support to be used along with less dense traditional supports, and/or a layered composite can be used with traditional supports up to 0.02 to 3 mm from the surface of the part and with erodible supports for the rest of the length.

In accordance with embodiments of the invention an erodible support material can be used in at least the interface between a part and a support structure. The region of erodible support material can, in various embodiments, can replace the inverted triangles inside the box 106 as shown in FIG. 1.

An erodible support structure methodology can beneficially allow for changing the orientation of a part within a build. Typically, the shorter a part can be oriented within the build chamber, the faster it can build, and the less it will cost. This is due to the recoating step, which takes approximately 20 seconds per layer on an EOS M290. Given layer thickness is typically 0.030 mm, and machine time is approximately $65/hr, this means reducing build height by 1 cm saves about 2 hours of build time, or $130 per build per cm of build height. Over a fleet of machines, this can lead to significant cost savings on machine time.

Finally, erodible new support material can also be used for printing structures which may otherwise be impossible. Several embodiments of the invention are capable of enabling 3d printing systems to generate Large, open trusses, octet trusses with larger horizontal members, thin walled structures, flexures, springs, compliant devices, and more. Erodible support structures permit the fabrication of a variety of new geometries previously not feasible in powder bed machines.

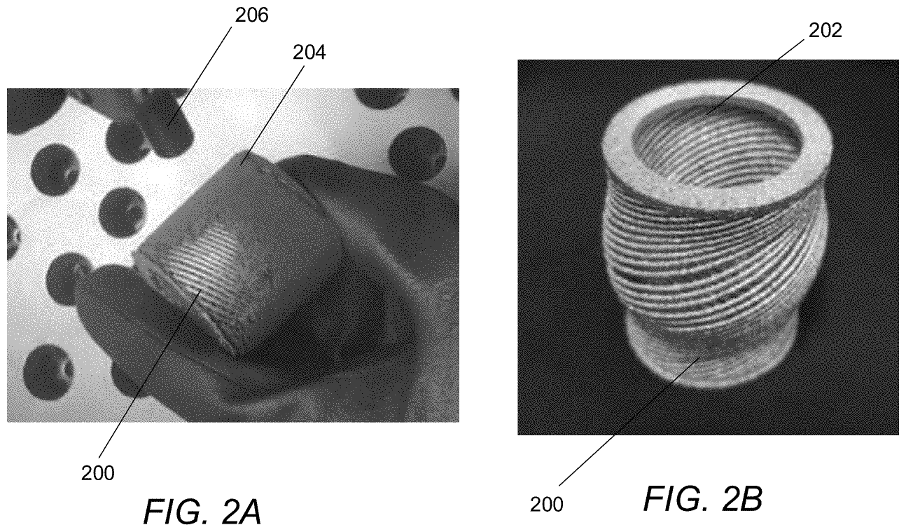

In accordance with embodiments of the invention, erodible support material can be 3d printed to support a desired structure. The erodible support material can then be eroded away. An example part printed with an enveloping erodible support structure is conceptually illustrated in FIG. 2A through B. A partially eroded support structure in the process of being eroded away via bead blasting is conceptually illustrated in FIG. 2A. The desired structure with all support structure removed is conceptually illustrated in FIG. 2B. Several embodiments of the invention can enable the production of previously unavailable geometries. For example, the geometry of an aluminum part 200 shown in FIG. 2A-B was previously only available with polymers. The part 200 was printed with the thin springs 202 embedded in an erodible support structure 204. The erodible support structure 204 was post-processed in a glass bead blaster 206 (as can be seen in FIG. 2A). The springs 202 were thin (1 mm) springs and can remain undamaged and flexible, while the erodible support structure 204 can be completely removed (e.g., by the bead blasting). FIG. 2A shows the part 200 around one second into bead blasting. The erodible support structure 204 is visible around the outside, with the springs 202 visible on the inside. Fully cleaning the part 200 took around 90 seconds of cleaning. For a recoater blade-based printer, the part 200 would previously have been too flexible to print, as it would distort during printing, snag the recoater, and cause a part failure. The erodible support structure 204 provided an anchor to hold the spring static, and thereby prevent distortion. In accordance with many embodiments of the of the invention, an erodible support can be printed such that it is configured to provide an anchor to hold a desired part static.

The use of erodible support structures can enable the printing of other flexures, living hinges, thin walled structures, and/or parts with steep overhangs, etc.

In accordance with embodiments of the invention, machine setting (e.g., laser settings) can be configured to generate very fragile structures. Parameter (e.g., process parameter) development studies can be performed to identify a palette of settings with different resistance to erosion and/or porosity. The parameters can be machine dependent. The parameters can be dependent on method of additive manufacturing. Erodible support structures can be used in a variety of additive manufacturing methods. In many cases, all of these settings would previously be considered build failures by the standard industry definitions. In various embodiments, an erodible support structure can have a first portion for easy erosion, and a second portion configured to have a high thermal conductivity. Controlling porosity can allow configuring of thermal properties of a support structure.

Process parameters of a 3d printing process can be controlled to control the erodibility of printed structures. Erodibility can be a function of porosity. Process parameters can include scan speed, laser power, cross-hatch spacing, layer thickness, rotation amount, beam spot size, beam focal size, and/or fill pattern. In accordance with many embodiments of the invention, an erodible structure can be a structure with a porosity greater than around 10%. In many embodiments, the porosity of an erodible structure can be around 35-40%. The porosity of an erodible structure can be around 35-40% at the interface with a part. In many embodiments, an erodible support structure can have at least some portion (e.g., the portion in contact with a supported part) that is erodible. Erodible can, in several embodiments, can require a porosity of at least around 20% or 25%. Erodible supports can be made with a variety of metals including at least aluminum, titanium, copper, steel, Ni-based alloys, Co-based alloys, Cr-based alloys, refractory metals, high entropy metals, intermetallics and/or other metals and/or materials.

In many embodiments, an erodible support structure can have varying porosity throughout. By varying the porosity throughout the erodible support structure, it is possible to select desirable thermal properties for the support structure. Selecting the porosity of the support structure can allow selecting a thermal performance of the erodible support structure. In many embodiments, an erodible support structure can have a first porosity in a first portion and a second higher porosity in a second portion. The second portion can be a portion that is in contact with the part. The first portion, the second portion, and/or the part can be made from the same material. In various embodiments the erodible support structure can have sufficient mechanical strength to support the part as necessary, but can also have the trait of being erodible. Eroding can be performed by mechanical means (e.g., bead blasting) and/or by chemical means (e.g., selective etching). Selective etching can, in some embodiment, remove porous material quickly due to increased surface area versus fully dense material. Mechanical and chemical means of removing support materials are, in several embodiments, performed as part of an automated process. In several embodiments chemical means can include the use of corrosion to erode an erodible structure. Erodible structures can be rapidly corrodible because of elevated porosity.

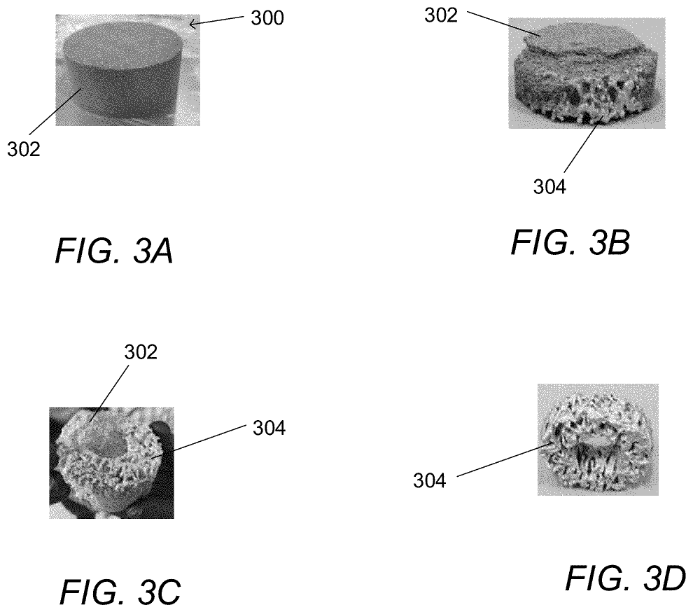

An example structure printed with erodible support, and the progressive removal of erodible support is conceptually illustrated in FIG. 3A through D. FIG. 3A shows a printed structure 300 including an erodible support structure 302. FIG. 3B shows the printed structure 300 after partial erosion of the erodible support structure 302, the desired structure 304 remains undamaged by the erosive process causing the erosion of the erodible support structure 302. FIG. 3C shows the printed structure 300 after further erosion of the erodible structure 302. FIG. 3D shows the desired structure 304 after full removal of the erodible structure 302. In several embodiments the erodible support structure and the desired structure are made of the same material. Some embodiments could use AlSi₁₀Mg. Some embodiments can have support structures configured to be eroded by steel beads. In some embodiments, the erodible support structure can be a lightly sintered porous structure. In numerous embodiments of the invention, an erodible support structure can be printed such that it fully envelopes a part. An output of an additive manufacturing process can be a print that includes a part (e.g., a desired output) and an erodible support structure.

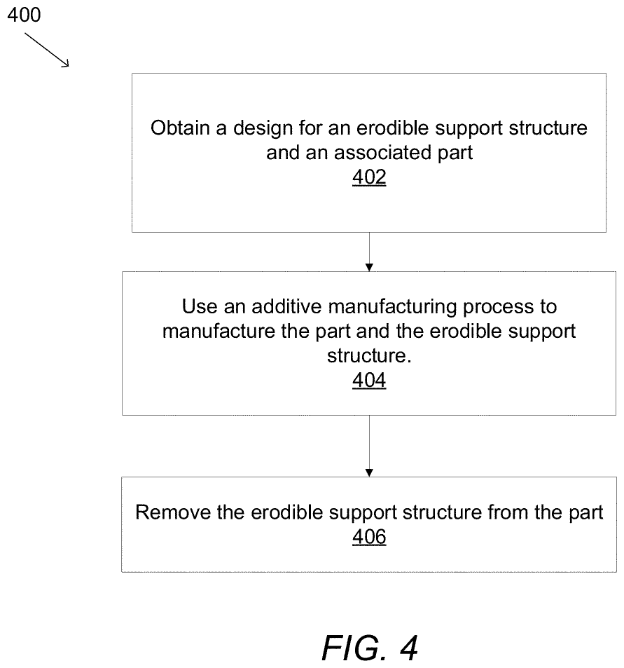

In various embodiments, an erodible support structure can be used as part of an additive manufacturing process. An example additive manufacturing process incorporating the use of an erodible support is conceptually illustrated in FIG. 4. The process 400 can obtain (402) a design for an erodible support and/or a part. In several embodiments, a process can generate a design for an erodible support based on a part and/or other user inputs (e.g., such as indication of thermal requirements). In some embodiments, an erodible support can have a porosity that varies throughout the erodible support. The process 400 can additively manufacture (404) the part and the erodible support structure. The process 400 can remove (406) the erodible support structure from the part. Removal of the erodible support structure can be by mechanical and/or chemical means. In some embodiments, the removal of the erodible support structure can be performed automatically.

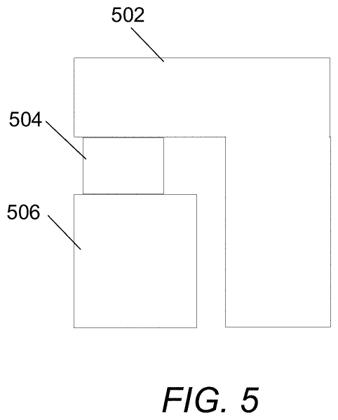

In various embodiments, an erodible support structure can have a porosity that varies throughout the structure. This can give the erodible support structure beneficial thermal and mechanical properties. An example of an erodible support structure showing various porosity portions supporting a part is conceptually illustrated in FIG. 5. A part 502 can be supported by an erodible support structure. The erodible support structure can include a first portion 504 and a second portion 506. The porosity of the first portion 504 can be different from the porosity of the second portion 506. The porosity within each portion, in various embodiments can be varied. The portion 504 can be in direct contact with the part 502. The porosity of portion 504 can be higher, or lower, than the porosity of the second portion. The porosity of the second portion can be greater than the porosity of the part 502.

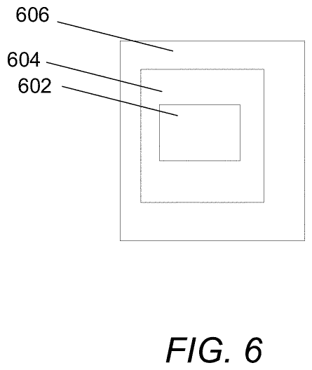

In accordance with embodiments of the invention, an erodible support structure can be used to surround a part. It can also have a porosity that varies throughout the structure. This can give the erodible support structure beneficial thermal and mechanical properties. An example of an erodible support structure showing various porosity portions surrounding a part is conceptually illustrated in FIG. 6. A part 602 can be supported by an erodible support structure. The erodible support structure can include a first portion 604 and a second portion 606. The porosity of the first portion 604 can be different from the porosity of the second portion 606. The porosity within each portion, in various embodiments can be varied. The portion 604 can be in direct contact with the part 502. The porosity of portion 604 can be higher than the porosity of the second portion. The porosity of the second portion can be greater than the porosity of the part 602. The erodible material can fully encapsulate the printed part in various embodiments. In a number of embodiments, an additive manufacturing output can include the first portion of an erodible support deposited such that it fully envelopes the part, and a second portion can be deposited such that the second portion envelopes the first portion.

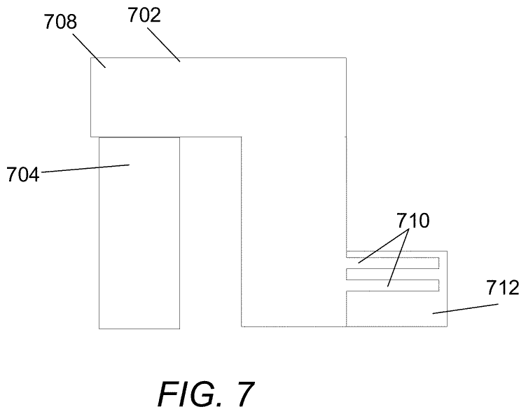

In accordance with several embodiments of the invention, an erodible support structure can have a porosity that varies throughout the structure. Erodible support structures can be used to support a part while being adjacent to a part (e.g., and in contact along at least one surface). Erodible support structures can be used to surround a part or a portion of a part. An example arrangement of erodible support structures with a supported part is conceptually illustrated in FIG. 7. A part 702 can be supported by at least one of the erodible support structures 704 and 712. The part 702 can include a first portion (e.g., an overhang) 708 and a second portion (e.g., a delicate portion) 710. The first portion 708 can be supported by the support structure 704. The second portion 710 can be supported by the second erodible support structure 712. The first erodible support structure can have varying porosity. The first erodible support structure 704 (and similar structures) can be configured to minimally contact the part 702. The second erodible support structure 712 can be configured to have variable porosity. The second support structure 712 can be configured to fully enclose the second portion 710. Erodible support structures can be configured to partially envelop (e.g., surround), and/or to fully envelop parts and/or portions of parts.

While specific geometries are described above and illustrated in the figures, an erodible support material could be used in many different geometries according to the part being printed. The erodible support materials can have their porosity configured so as to provide sufficient mechanical strength and beneficial thermal properties.

### DOCTRINE OF EQUIVALENTS

While the above description contains many specific embodiments of the invention, these should not be construed as limitations on the scope of the invention, but rather as an example of one embodiment thereof. It is therefore to be understood that the present invention may be practiced in ways other than specifically described, without departing from the scope and spirit of the present invention. Thus, embodiments of the present invention should be considered in all respects as illustrative and not restrictive. Accordingly, the scope of the invention should be determined not by the embodiments illustrated, but by the appended claims and their equivalents.

What is claimed is:

1. A process for improving precision in additive manufacturing processes, the process comprising:
obtaining a design for an erodible support structure and a part; and
using an additive manufacturing process to manufacture the part and the erodible support structure,
wherein the erodible support structure is configured to mechanically support the part during the additive manufacturing process, and wherein the erodible support structure has a porosity greater than 10%.

2. The process of claim 1, the process further comprising removing the erodible support structure from the part.

3. The process of claim 2, the process further comprising removing the erodible support structure from the part by mechanical means.

4. The process of claim 1, wherein the erodible support structure is configured to have selected thermal properties based on varying the porosity throughout the erodible support structure.

5. The process of claim 1, wherein the erodible support structure is deposited such that it at least partially envelopes the part.

6. The process of claim 1, wherein the erodible support and the part are made of a common material.

7. The process of claim 1, wherein the porosity of the erodible support is achieved by varying process parameters, and wherein process parameters can consist of at least one from a list of: scan speed, laser power, cross-hatch spacing, layer thickness, rotation amount, beam spot size, beam focal size, and/or fill pattern.

8. The process of claim 1, wherein the erodible support structure has a porosity greater than around 20%.

9. The process of claim 1, wherein the erodible support structure has a porosity greater than around 35%.

10. The process of claim 2, the process further comprising removing the erodible support structure from the part by bead blasting.

11. The process of claim 2, the process further comprising removing the erodible support structure from the part by chemical means.

12. The process of claim 2, the process further comprising removing the erodible support structure from the part by corroding away at least a portion of the erodible support structure.

13. A process for improving precision in additive manufacturing processes, the process comprising:
obtaining a design for an erodible support structure and a part; and
using an additive manufacturing process to manufacture the part and the erodible support structure,
wherein the erodible support structure is configured to mechanically support the part during the additive manufacturing process, and wherein the erodible support structure has a first portion with a first porosity and a second portion with a second porosity, the first porosity different from the second porosity.

14. The process of claim 13, the process further comprising removing the erodible support structure from the part.

15. The process of claim 14, the process further comprising removing the erodible support structure from the part by abrasive means.

16. The process of claim 13, wherein the first portion has a higher percent porosity than the second portion, and the part is around fully dense.

17. The process of claim 13, wherein the first portion has a porosity greater than around 20%.

18. The process of claim 13, wherein the first portion is configured to be erodible and the second portion is configured to be not erodible.

19. The process of claim 13, wherein the first portion is configured to be erodible by bead blasting the second portion is configured to have a higher effective thermal conductivity than the first portion.

20. An additive manufacturing output, the additive manufacturing output comprising:
a part; and
an erodible support structure, the erodible support structure configured to mechanically support the part during an additive manufacturing process, and wherein the erodible support structure has a first portion with a first porosity and a second portion with a second porosity, the first porosity different from the second porosity.
